(19) United States
(12) Patent Application Publication
(10) Pub. No.: US 2022/0281665 A1
(43) Pub. Date: Sep. 8, 2022

(54) RECLOSABLE PACKAGES AND PACKAGED PRODUCTS

(71) Applicant: AMCOR FLEXIBLES NORTH AMERICA, INC., Neenah, WI (US)

(72) Inventor: Reinaldo V. Caleman, Jr., Neenah, WI (US)

(21) Appl. No.: 17/637,412

(22) PCT Filed: Aug. 28, 2019
(86) PCT No.: PCT/US2019/048792

§ 371 Date: Feb. 22, 2022

(51) Int. Cl. B65D 75/58; B65D 75/32

(52) U.S. Cl. CPC B65D 75/5838; B65D 75/326; B65D 75/5855; B65D 2575/586; B65D 2575/3245

(57) ABSTRACT

A package includes a package body having a top portion, a bottom portion, and side portions connecting the bottom portion to the top portion. The bottom portion and the side portions define a recessed cavity. The top portion includes an opening providing access to the recessed cavity and a plurality of flexible portions positioned at a periphery of the opening. The package further includes a peelable and resealable label adhesively sealed to the top portion of the package body to cover the opening. The opening is at least partially exposed upon peeling of the label allowing removal of a product received within the recessed cavity. During removal of the product from the package body, the flexible portions flex upwardly away from the recessed cavity upon engagement with the product.

### TECHNICAL FIELD

The present application relates generally to packaging, and in particular to reclosable packages and packaged products.

### BACKGROUND

The use of labels for accessing and/or repeatedly accessing the contents of a package are known. The package typically includes an opening which is covered by a label. In some applications, the opening of the package is cut with a die and the package is referred to as a die-cut label (DCL) package. The label is bonded to a reclosable area by an adhesive. For some applications that include food, the reclosable area is susceptible to contamination by the product (liquid, grease, etc. that may exude from the product). For example, with the packaging of a product, such as bacon or other greasy products, the reclosable area may be at least partly contaminated by a layer of grease or liquid that has transferred from the product to the reclosable area. Such contamination may not allow re-closability regardless of adhesion quality of the adhesive.

Re-closability is a valued feature by users of packages that include labels. A closed package provides freshness or perceived freshness of the product contained therein. Further, a reclosed package prevents spillage of the contained product and/or leakage of liquid (water, juices, blood, etc. from the contained product) from the package. Users experience less waste and mess when they are able to reclose the package.

Thus, a need exists for a reclosable label package that can be reclosed without contamination to the reclosable area.

### SUMMARY

A package has been developed with a peelable and resealable label bonded to a reclosable area to cover an opening. A plurality of flexible portions positioned at a periphery of the opening may prevent or reduce contamination of the reclosable area.

One embodiment of the package includes a package body having a top portion, a bottom portion, and side portions connecting the bottom portion to the top portion. The bottom portion and the side portions define a recessed cavity. The top portion includes an opening providing access to the recessed cavity and a plurality of flexible portions positioned at a periphery of the opening. The package further includes a peelable and resealable label adhesively sealed to the top portion of the package body to cover the opening. The opening is at least partially exposed upon peeling of the label allowing removal of a product received within the recessed cavity. During removal of the product from the package body, the flexible portions flex upwardly away from the recessed cavity upon engagement with the product.

In some embodiments, each flexible portion is a projection positioned at the periphery of the opening. In some embodiments, each projection is V-shaped, U-shaped, or curved.

In some embodiments, each flexible portion is adjacent to a slit extending from the periphery of the opening into the top portion. In some embodiments, each slit is perpendicular to the periphery of the opening.

In some embodiments, a length of each flexible portion is within a range from 1 mm to 50 mm.

In some embodiments, a distance between adjacent flexible portions is within a range from 0 mm to 100 mm.

In some embodiments, each flexible portion is normally disposed in an unflexed position co-planar with the top portion of the package body. Further, the flexible portions that engaged with the product return to the unflexed position after removal of the product from the package body.

In some embodiments, the top portion of the package body includes a lidding film. The lidding film includes the plurality of flexible portions.

In some embodiments, the label is adhesively sealed to the lidding film over a reclosable area. The reclosable area surrounds the opening and is disposed adjacent to the plurality of flexible portions.

In some embodiments, the opening is U-shaped with a pair of curved ends.

In some embodiments, the bottom portion and the side portions of the package body include a thermoformed tray.

In some embodiments, the label includes an unsealed pull tab.

One embodiment of a packaged product includes a package body having a top portion, a bottom portion, and side portions connecting the bottom portion to the top portion. The bottom portion and the side portions define a recessed cavity. The top portion includes an opening providing access to the recessed cavity and a plurality of flexible portions positioned at a periphery of the opening. The packaged product further includes a product received within the recessed cavity of the package body. The package further includes a peelable and resealable label adhesively sealed to the top portion of the package body to cover the opening. The opening is at least partially exposed upon peeling of the label allowing removal of the product from the package body. During removal of the product from the package body, the flexible portions flex upwardly away from the recessed cavity upon engagement with the product.

In some embodiments, each flexible portion is a projection positioned at the periphery of the opening. In some embodiments, each projection is V-shaped, U-shaped, or curved.

In some embodiments, each flexible portion is adjacent to a slit extending from the periphery of the opening into the top portion. In some embodiments, each slit is perpendicular to the periphery of the opening.

One embodiment of a package includes a package body having a top portion, a bottom portion, and side portions connecting the bottom portion to the top portion. The bottom portion and the side portions define a recessed cavity. The top portion includes an opening providing access to the recessed cavity and a plurality of flexible projections positioned at a periphery of the opening and disposed adjacent to each other. The package further includes a peelable and resealable label adhesively sealed to the top portion of the package body to cover the opening. The opening is at least partially exposed upon peeling of the label allowing removal of a product received within the recessed cavity. During removal of the product from the package body, the flexible projections flex upwardly away from the recessed cavity upon engagement with the product. In some embodiments, each flexible projection is V-shaped, U-shaped, or curved.

There are several aspects of the present subject matter which may be embodied separately or together. These aspects may be employed alone or in combination with other aspects of the subject matter described herein, and the description of these aspects together is not intended to preclude the use of these aspects separately or the claiming of such aspects separately or in different combinations.

### BRIEF DESCRIPTION OF THE DRAWINGS

The disclosure may be more completely understood in consideration of the following detailed description of various embodiments of the disclosure in connection with the accompanying drawings, in which:

FIG. 1 illustrates a schematic perspective view of one embodiment of a package in a “closed state”;

FIG. 2 illustrates a schematic top view of one embodiment of the package depicted in FIG. 1;

FIG. 3 illustrates a schematic perspective view of one embodiment of the package depicted in FIG. 1 in an “open state”;

FIGS. 4A-4C show an exemplary method of removing a product from the package; and

FIGS. 5A-5F illustrate various embodiments of flexible portions of the package.

The figures are not necessarily to scale. Like numbers used in the figures refer to like components. It will be understood, however, that the use of a number to refer to a component in a given figure is not intended to limit the component in another figure labeled with the same number.

### DETAILED DESCRIPTION

The present application describes a package and a packaged product including the package. The package includes a package body having a top portion, a bottom portion, and side portions connecting the bottom portion to the top portion. The bottom portion and the side portions define a recessed cavity. The top portion includes an opening providing access to the recessed cavity and a plurality of flexible portions positioned at a periphery of the opening. The package further includes a peelable and resealable label adhesively sealed to the top portion of the package body to cover the opening. The opening is at least partially exposed upon peeling of the label allowing removal of a product received within the recessed cavity. During removal of the product from the package body, the flexible portions flex upwardly away from the recessed cavity upon engagement with the product. The upward flexing of the flexible portions may prevent or reduce contamination of a reclosable area that bonds with the label. Therefore, the label may continue to reseal the opening effectively even after removal of the product multiple times. This is in contrast to current packages whose reclosable areas can be contaminated by products. Such contamination in current packages may prevent proper resealing of the labels.

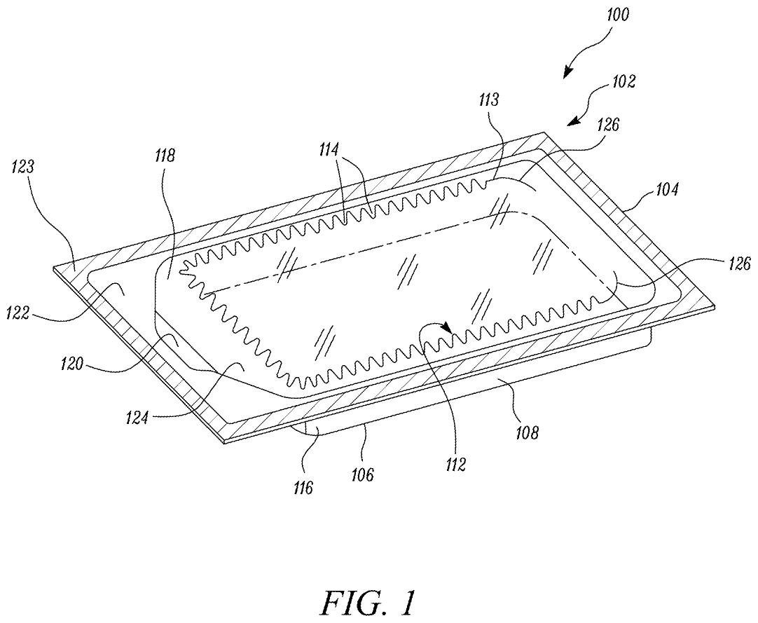

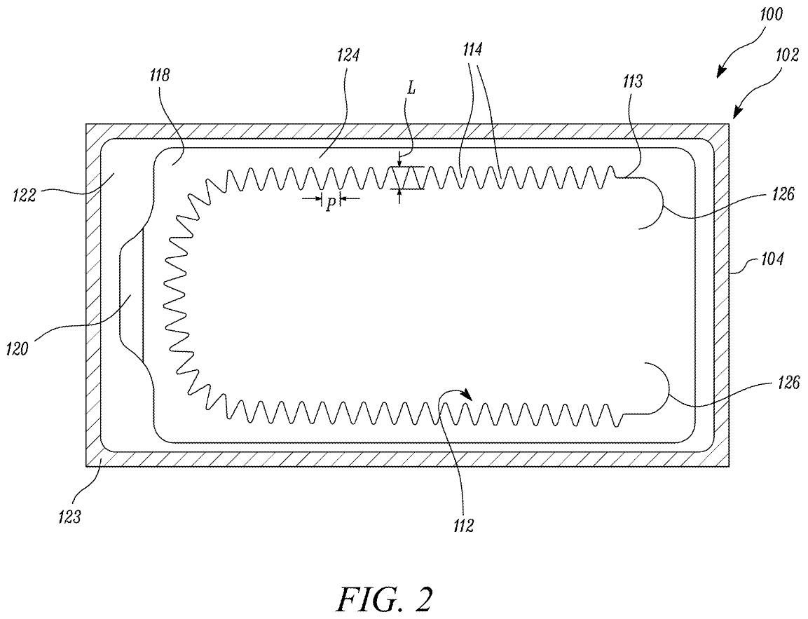

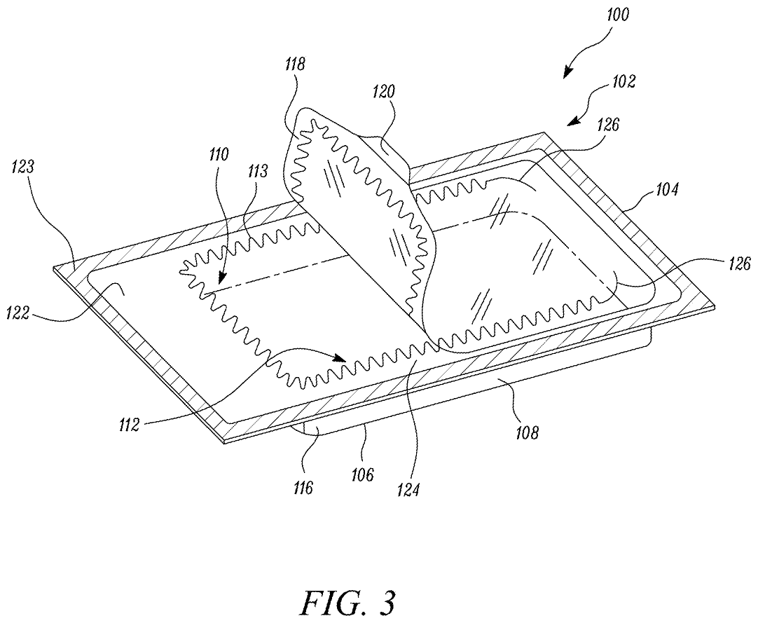

One embodiment of a package 100 is illustrated in FIG. 1. FIG. 2 is a top view of package 100. FIG. 3 illustrates package 100 in an “open state”. Referring to FIGS. 1 to 3, package 100 includes a package body 102 having a top portion 104, a bottom portion 106 and side portions 108 connecting bottom portion 106 to top portion 104. Bottom portion 106 and side portions 108 define a recessed cavity 110 (shown in FIG. 3). Top portion 104 includes an opening 112 providing access to recessed cavity 110. Top portion 104 further includes a plurality of flexible portions 114 positioned at a periphery 113 of opening 112.

In this embodiment, bottom portion 106 and side portions 108 of package body 102 include a thermoformed tray 116 (hereinafter referred to as “tray 116”). Specifically, the combined bottom portion 106 and side portions 108 are in the form of tray 116. Tray 116 may be of any desired shape, such as, for example, rectangular, square, circular or polygonal depending on both functional and aesthetic requirements. Tray 116 may be thermoformed to any depth as desired depending upon type and amount of food or non-food product to be packaged. Though in the illustrated embodiment, tray 116 includes one recessed cavity 110, it should also be appreciated that tray 116 may be configured to include two or more recessed areas (not shown) depending again on both functional and aesthetic requirements of a particular packaging application. Tray 116 may be made of a polymeric material, a metallic material, or a combination thereof. In some embodiments, thermoformed tray 116 includes a sealing flange (not shown) extending around a periphery of recessed cavity 110 to facilitate the sealing of a lidding film 122.

Package 100 further includes a peelable and resealable label 118 adhesively sealed to top portion 104 of package body 102 to cover opening 112. Peelable and resealable label 118 may be interchangeably referred to as label 118. In some embodiments, label 118 includes an unsealed pull tab 120. In some cases, label 118 may be made of a polypropylene film coated on one face with a pressure sensitive adhesive. In some embodiments, label 118 may be a multilayer film, that is, a film including more than one layer, and one of the layers may include a barrier material, such as ethylene vinyl alcohol copolymer (EVOH), or any other barrier material as is known in the art. Label 118 may have any suitable shape, for example, rectangular, square, polygonal, circular or elliptical depending on both functional and aesthetic requirements.

In some embodiments, top portion 104 of package body 102 includes lidding film 122. Lidding film 122 further includes plurality of flexible portions 114. Lidding film 122 may be made of a polymeric material, such as polypropylene. In some embodiments, the lidding film 122 may be a monolayer or multilayer film. In some embodiments where lidding film 122 is a monolayer film, the lidding film may include oriented polypropylene (OPP) or polyester (PET), as non-limiting examples. In some embodiments where lidding film 122 is a multilayer film, the structure may include an extruded, multilayer film or a laminate. A non-limiting example of a suitable laminate includes an oriented polyester (OPP) film that is printed with ink and then adhesively laminated to a barrier sealant film that can be a multilayer, extruded film including a layer of EVOH sandwiched between layers of polyethylene (PE). In some embodiments, lidding film 122 is sealed to the sealing flange of tray 116 over a sealing area 123. In some embodiments, label 118 is adhesively sealed to lidding film 122 over a reclosable area 124. In some embodiments, reclosable area 124 surrounds opening 112 and is disposed adjacent to plurality of flexible portions 114. Label 118 is larger than opening 112 in order to bond with reclosable area 124. In the illustrated embodiment, opening 112 is U-shaped with a pair of curved ends 126. In some embodiments, the curved ends 126 may be curved to such a degree that they function as “stops” that prevent the label 118 from being completely removed from the lidding film 122 as is known in the art. However, opening 112 may be of any desired shape, such as, for example, O-shaped, C-shaped, V-shaped or oval depending on both functional and aesthetic requirements. In some embodiments, the when periphery 113 of opening 112 is a closed shape (e.g., O-shaped), label 118 may be completely removed from the lidding film 122. In some cases, opening 112 may be a die-cut opening. In an example, flexible portions 114 may be formed by die-cutting. Opening 112 is at least partially exposed upon peeling of label 118 allowing removal of a product (not shown in FIGS. 1 and 2) received within recessed cavity 110. Recessed cavity 110 may be of any desired shape, such as, for example, rectangular, square, circular or polygonal depending on both functional and aesthetic requirements.

Package body 102 along with the product received within recessed cavity 110 form a packaged product. During removal of the product from package body 102, flexible portions 114 flex upwardly away from recessed cavity 110 upon engagement with the product. In some embodiments, each flexible portion 114 is normally disposed in an unflexed position co-planar with top portion 104 of package body 102. Further, flexible portions 114 that engaged with the product return to the unflexed position after removal of the product from package body 102.

In some embodiments, each flexible portion 114 is a projection positioned at periphery 113 of opening 112. In some embodiments, each projection is V-shaped, U-shaped, or curved. For example, as depicted in FIGS. 1 and 2, each flexible portion 114 is a V-shaped projection. In some other embodiments, each flexible portion 114 is adjacent to a slit (not shown in FIGS. 1 and 2) extending from periphery 113 of opening 112 into top portion 104. Adjacent flexible portions 114 may be separated by a corresponding slit. In some embodiments, each slit is perpendicular to periphery 113 of opening 112. Each slit may extend from periphery 113 of opening 112 to a boundary of reclosable area 124.

In some embodiments, a length “L” of each flexible portion 114 is within a range from 1 millimeter (mm) to 50 mm. Length “L” of each flexible portion 114 may be defined perpendicular to periphery 113 of opening 112. In some embodiments, a distance between adjacent flexible portions 114 is within a range from 0 mm to 100 mm. For example, as depicted in FIGS. 1 and 2, flexible portions 114 are flexible projections disposed adjacent to each other. Therefore, the distance between adjacent flexible portions 114 is substantially 0 mm. In some embodiments, a pitch “P” of flexible portions 114 is within a range from 1 mm to 100 mm.

As is illustrated in FIGS. 1 and 2, package 100 is shown in a “closed state” with label 118 bonded to reclosable area 124 and covering opening 112. In some embodiments, package 100 may also include a line of weakness (not shown) in a portion of pull tab 120 and boundaries of reclosable area 124. When label 118 is peeled away from package 100 for the first time, the portion of package body 102 having the line of weakness may be completely removed from package 100. In other embodiments, the portion of package body 102 having the line of weakness may fold backwards and remain attached to package 100 when label 118 is peeled away from package 100. FIG. 3 illustrates package 100 in the “open state” with label 118 peeled away to at least partially expose opening 112. When label 118 is peeled away, a face of label 118 may have an area of exposed pressure sensitive adhesive around its margin. This exposed area of adhesive may permit label 118 to reseal to package 100 and close opening 112.

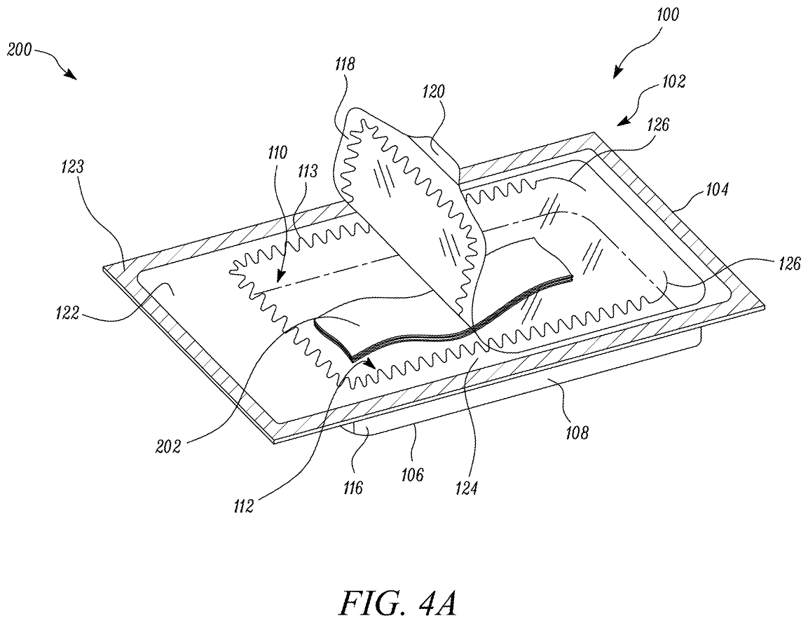

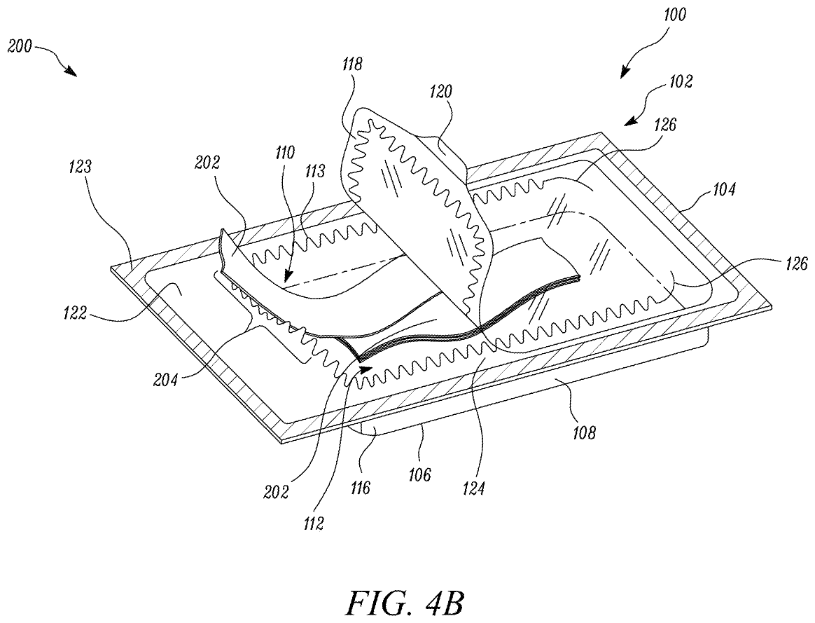

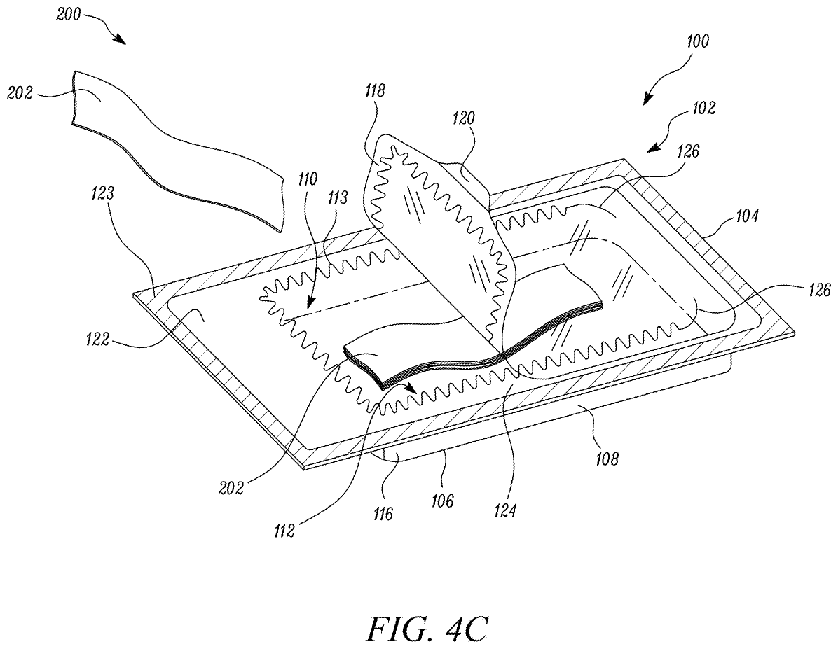

FIGS. 4A-4C show a packaged product 200 including package body 102 and a product 202 received within recessed cavity 110 of package body 102. Product 202 may include food and non-food items. Non-limiting examples of food items that may be disposed in package 100 include meats and cheeses. A further non-limiting example of a food item is processed meat, such as bacon, turkey bacon or ham. In some cases, multiple slices or strips of product 202 (e.g., bacon) may be received within recessed cavity 110. In some cases, product 202 may be greasy and may therefore include a product contaminant (e.g., grease or juice).

As shown in FIG. 4A, label 118 is peeled away to at least partially expose opening 112. Product 202 can now be accessed. As depicted in FIG. 4A, each flexible portion 114 is normally disposed in the unflexed position co-planar with top portion 104 of package body 102. Specifically, each flexible portion 114 is substantially co-planar with reclosable area 124 in the unflexed position.

FIG. 4B shows product 202 being removed from package body 102. As depicted in FIG. 4B, product 202 is partly removed from package body 102. During removal of product 202, product 202 engages with a number of flexible portions 114. Flexible portions 114 flex upwardly away from recessed cavity 110 upon engagement with product 202. In a flexed position, flexible portions 114 are inclined to a horizontal plane. Flexible portions 114 that flex upwardly may result in a formation of a non-contamination reseal zone 204. Non-contamination reseal zone 204 may prevent product 202 from contaminating reclosable area 124 of lidding film 122. Specifically, flexible portions 114 in non-contamination reseal zone 204 may prevent or reduce contact between product 202 and reclosable area 124 because product 202 may slide on a bottom surface of lidding film 122 when flexible portions 114 are flexed, thereby containing the product contaminant within an interior of package body 102. Contamination of reclosable area 124 by product 202 may therefore be prevented or reduced.

FIG. 4C shows product 202 being completely removed from package body 102. Flexible portions 114 that engaged with product 202 return to the unflexed position after removal of product 202 from package body 102. Specifically, flexible portions 114 in non-contamination reseal zone 204 return to the unflexed position after removal of product 202 from package body 102. The unflexed position of flexible portions 114 may allow improved resealing of label 118 to reclosable area 124.

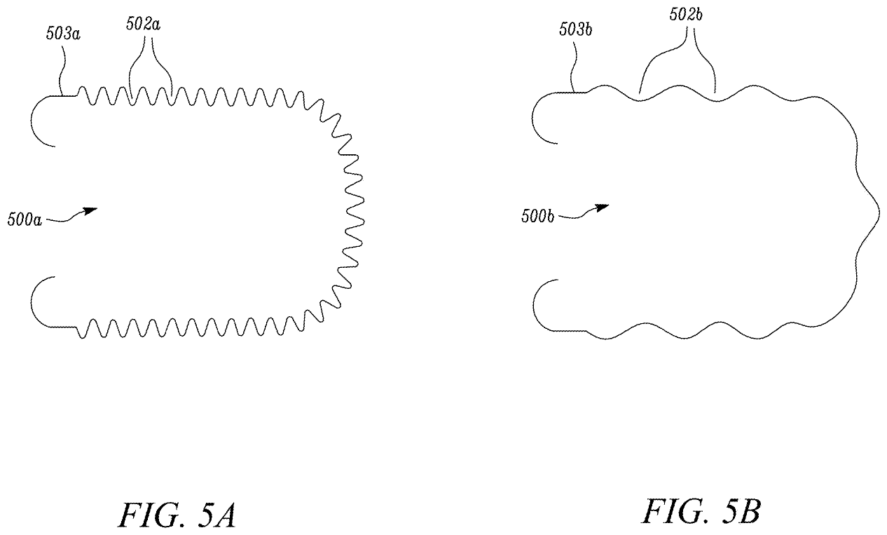

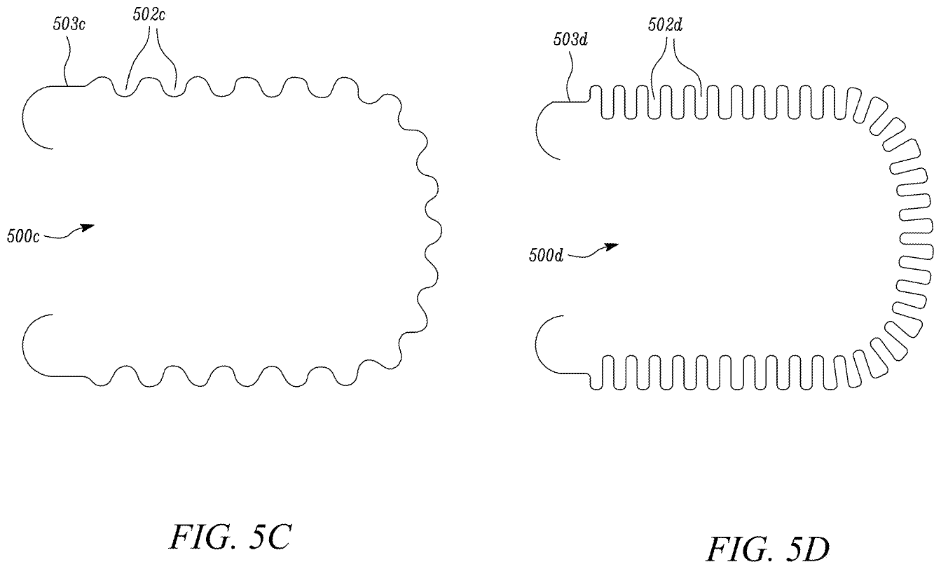

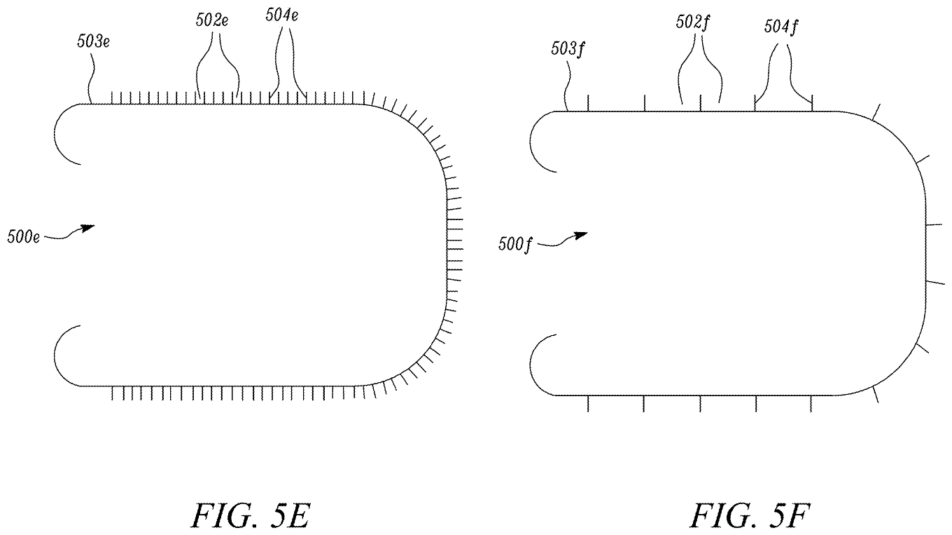

FIGS. 5A to 5F illustrate different types of flexible portions that can be used with a package (e.g., package 100) and a packaged product (e.g., packaged product 200) of the present application. In some embodiments, each set of flexible portions shown in FIGS. 5A to 5F may form part of a die-cut opening.

FIG. 5A shows an opening 500a and a plurality of flexible projections 502a positioned at a periphery 503a of opening 500a. Flexible projections 502a are V-shaped and are disposed adjacent to each other. A tip of each flexible projection 502a may be rounded. FIG. 5B shows an opening 500b and a plurality of flexible projections 502b positioned at a periphery 503b of opening 500b. Flexible projections 502b are curved and are disposed adjacent to each other. Further, flexible projections 502b form alternating concave and convex regions. FIG. 5C shows an opening 500c and a plurality of flexible projections 502c that are positioned at a periphery 503c of opening 500c. Flexible projections 502c are approximately U-shaped and are disposed adjacent to each other. FIG. 5D shows an opening 500d and a plurality of flexible projections 502d positioned at a periphery 503d of opening 500d. Flexible projections 502d are U-shaped and are disposed adjacent to each other. In some embodiments, a pitch of flexible projections 502d is less than a pitch of flexible projections 502c. In some embodiments, the pitch of flexible projections 502c is less than a pitch of flexible projections 502b. Though flexible projections 502a, 502b, 502c, 502c in each set are disposed adjacent to each other, adjacent flexible projections 502a, 502b, 502c, 502c may be uniformly or non-uniformly separated from each other by respective distances.

FIG. 5E illustrates an opening 500e and a plurality of flexible portions 502e positioned at a periphery 503e of opening 500e. Each flexible portion 502e is disposed adjacent to a slit 504e. Specifically, each flexible portion 502e is separated from adjacent flexible portion 502e by corresponding slit 504e. Each slit 504e may extend from periphery 503e of opening 500e into a top portion of a package body (not shown in FIG. 5E). Each slit 504e may have any suitable shape, for example, linear, curved, etc. In some embodiments, each slit 504e is substantially perpendicular to periphery 503e of opening 500e. In some other embodiments, each slit 504e may be obliquely inclined to periphery 503e of opening 500e. Each flexible portion 502e may have a rectangular shape.

FIG. 5F illustrates an opening 500f and a plurality of flexible portions 502f positioned at a periphery 503f of opening 500f. Each flexible portion 502f is disposed adjacent to a slit 504f. Specifically, each flexible portion 502f is separated from adjacent flexible portion 502f by corresponding slit 504f. Each slit 504f may extend from periphery 503f of opening 500f into a top portion of a package body (not shown in FIG. 5F). Each slit 504f may have any suitable shape, for example, linear, curved, etc. In some embodiments, each slit 504f is substantially perpendicular to periphery 503f of opening 500f. In some other embodiments, each slit 504f may be obliquely inclined to periphery 503f of opening 500f. Each flexible portion 502f may have a rectangular shape. Further, a pitch of flexible portions 502f is greater than a pitch of flexible portions 502e.

Slit 504e, 504f may be a continuous cut. In other embodiments, slit 504e, 504f may be a plurality of intermittent cuts (perforations) or scores that separate along the intermittent cut or score when product 202 is brought against flexible portions 502e, 502f that allow the flexible portions 502e, 502f to flex upwardly upon product 202 removal. Slit 504e, 504f may be formed through mechanical means, laser or other methods as known by one of skill in the art.

Each and every document cited in this present application, including any cross referenced, is incorporated in this present application in its entirety by this reference, unless expressly excluded or otherwise limited. The citation of any document is not an admission that it is prior art with respect to any embodiment disclosed in this present application or that it alone, or in any combination with any other reference or references, teaches, suggests, or discloses any such embodiment. Further, to the extent that any meaning or definition of a term in this present application conflicts with any meaning or definition of the same term in a document incorporated by reference, the meaning or definition assigned to that term in this present application governs.

The description, examples, embodiments, and drawings disclosed are illustrative only and should not be interpreted as limiting. As briefly described above, the reader should assume that features of one disclosed embodiment can also be applied to all other disclosed embodiments, unless expressly indicated to the contrary. Unless expressly indicated to the contrary, the numerical parameters set forth in the present application are approximations that can vary depending on the desired properties sought to be obtained by a person of ordinary skill in the art without undue experimentation using the teachings disclosed in the present application. Modifications and other embodiments will be apparent to a person of ordinary skill in the packaging arts, and all such modifications and other embodiments are intended and deemed to be within the scope of the present invention.

1. A package comprising:
a package body having a top portion, a bottom portion and side portions connecting the bottom portion to the top portion, wherein the bottom portion and the side portions define a recessed cavity, wherein the top portion comprises an opening providing access to the recessed cavity and a plurality of flexible portions positioned at a periphery of the opening; and
a peelable and resealable label adhesively sealed to the top portion of the package body to cover the opening, wherein the opening is at least partially exposed upon peeling of the label allowing removal of a product received within the recessed cavity;
wherein, during removal of the product from the package body, the flexible portions flex upwardly away from the recessed cavity upon engagement with the product.

2. The package of claim 1, wherein each flexible portion is a projection positioned at the periphery of the opening.

3. The package of claim 2, wherein each projection is V-shaped, U-shaped, or curved.

4. The package of claim 1, wherein each flexible portion is adjacent to a slit extending from the periphery of the opening into the top portion.

5. The package of claim 4, wherein each slit is perpendicular to the periphery of the opening.

6. The package of claim 1, wherein a length of each flexible portion is within a range from 1 mm to 50 mm.

7. The package of claim 1, wherein a distance between adjacent flexible portion is within a range from 0 mm to 100 mm.

8. The package of claim 1, wherein each flexible portion is normally disposed in an unflexed position co-planar with the top portion of the package body, wherein the flexible portions that engaged with the product return to the unflexed position after removal of the product from the package body.

9. The package of claim 1, wherein the top portion of the package body comprises a lidding film, wherein the lidding film comprises the plurality of flexible portions.

10. The package of claim 9, wherein the label is adhesively sealed to the lidding film over a reclosable area, wherein the reclosable area surrounds the opening and is disposed adjacent to the plurality of flexible portions.

11. The package of claim 1, wherein the opening is U-shaped with a pair of curved ends.

12. The package of claim 1, wherein the bottom portion and the side portions of the package body comprise a thermoformed tray.

13. The package of claim 1, wherein the label comprises an unsealed pull tab.

14. A packaged product comprising:
a package body having a top portion, a bottom portion and side portions connecting the bottom portion to the top portion, wherein the bottom portion and the side portions define a recessed cavity, wherein the top portion comprises an opening providing access to the recessed cavity and a plurality of flexible portions positioned at a periphery of the opening;
a product received within the recessed cavity of the package body; and
a peelable and resealable label adhesively sealed to the top portion of the package body to cover the opening, wherein the opening is at least partially exposed upon peeling of the label allowing removal of the product from the package body;
wherein, during removal of the product from the package body, the flexible portions flex upwardly away from the recessed cavity upon engagement with the product.

15. The packaged product of claim 14, wherein each flexible portion is a projection positioned at the periphery of the opening.

16. The packaged product of claim 15, wherein each projection is V-shaped, U-shaped, or curved.

17. The packaged product of claim 14, wherein each flexible portion is adjacent to a slit extending from the periphery of the opening into the top portion.

18. The packaged product of claim 17, wherein each slit is perpendicular to the periphery of the opening.

19. A package comprising:
a package body having a top portion, a bottom portion and side portions connecting the bottom portion to the top portion, wherein the bottom portion and the side portions define a recessed cavity, wherein the top portion comprises an opening providing access to the recessed cavity and a plurality of flexible projections positioned at a periphery of the opening and disposed adjacent to each other; and
a peelable and resealable label adhesively sealed to the top portion of the package body to cover the opening, wherein the opening is at least partially exposed upon peeling of the label allowing removal of a product received within the recessed cavity;
wherein, during removal of the product from the package body, the flexible projections flex upwardly away from the recessed cavity upon engagement with the product.

20. The package of claim 19, wherein each flexible projection is V-shaped, U-shaped, or curved.
